(19) United States
(12) Patent Application Publication
(10) Pub. No.: US 2026/0264087 A1
(43) Pub. Date: Sep. 10, 2026

(54) A GEAR WELL FOR A CRUSHER AND A CRUSHER COMPRISING THE GEAR WELL

(71) Applicant: Metso Finland Oy, Espoo (FI)

(72) Inventors: Wiljami NURMELA, TAMPERE (FI); Petri KUJANSUU, TAMPERE (FI)

(73) Assignee: Metso Finland Oy, Espoo (FI)

(21) Appl. No.: 18/871,716

(22) PCT Filed: Jun. 9, 2023
(86) PCT No.: PCT/EP2023/065438

§ 371 Date: Dec. 4, 2024

(30) Foreign Application Priority Data
Jun. 9, 2022 (EP) 22178102.4

(51) Int. Cl. B02C 2/04

(52) U.S. Cl. CPC B02C 2/04

(57) ABSTRACT

A gear well for a crusher that includes a hub circumventing portion, arrangeable for circumventing at least a portion of a hub of the crusher. The hub circumventing portion includes a groove having first and second side walls and a groove base, a pinion recess having a bottom, and a transition zone extending between an end of the hub circumventing portion and the pinion recess. The transition zone provides a stepped transition of the groove from the hub circumventing portion to the bottom of the pinion recess. A crusher that includes the gear well is also disclosed.

### FIELD OF THE DISCLOSURE

The present disclosure relates to gear well for a crusher and a crusher comprising a gear well.

### BACKGROUND ART

Crushers are well known in the art. They are utilized to reduce the size of rocks and stones in e.g., aggregates, recycling, and mining applications into desired dimensions. A gyratory or cone crusher are suitable for size reduction and shaping of material in the downstream of a crushing circuit. The material size is reduced by continuous compression between a fixed element, known as a bowl liner, and a moving element, known as a mantle. In addition, the crusher comprises a head assembly including a crusher head that gyrates about a vertical axis within a bowl attached to a main frame of the crusher. The crusher head is assembled surrounding an eccentric that rotates about a shaft to impart the gyratory motion to the crusher head which crushes rock, stone or other material as the material travels through a crushing gap between the crusher head and the bowl. The crushed material exits the crusher through the bottom of the crushing gap. The eccentric may be driven by a variety of power drives, such as an attached gear, driven by a pinion and countershaft assembly, and a number of mechanical power sources, such as electrical motors or combustion engines. The crusher typically comprises a gear well configured to lubricate the gear and/or the pinion and countershaft assembly.

A problem with the gear wells of today is that they comprise a sharp corner transition, which may be referred to as a precipice, along which the lubricating oil is travelling. A drawback with the precipice is that it generates great stresses in castings of the crusher which may, among other things, reduce the lifetime of the gear well.

The conventional gear wells are associated with several drawbacks. Thus, there is a need in the art for improvements in terms of reducing stresses in the castings, improving oil distribution as well as improving the lifetime of the gear well.

### SUMMARY

It is an object to mitigate, alleviate or eliminate one or more of the above-identified deficiencies in the art and disadvantages singly or in any combination and solve at least the above-mentioned problem.

According to a first aspect there is provided a gear well for a crusher comprising:

a hub circumventing portion, arrangeable for circumventing at least a portion of a hub of the crusher, and comprising a groove having first and second side walls and a groove base;

a pinion recess having a bottom; and

a transition zone extending between an end of the hub circumventing portion and the pinion recess,

wherein the transition zone provides a stepped transition of the groove from the hub circumventing portion to the bottom of the pinion recess.

In this context, the hub circumventing portion and the pinion recess are arranged at a distance from each other seen along a central axis of the hub of the crusher, wherein the transition zone extends between the hub circumventing portion and the pinion recess. The hub may be circumvented by the hub circumventing portion, the pinion recess, and the transition zone.

Preferably, the gear well comprises two transition zones, wherein one transition zone extends between a first end of the hub circumventing portion and the pinion recess and another transition zone extends between a second, opposite, end of the hub circumventing portion and the pinion recess. Thereby, the hub may be circumvented by the hub circumventing portion, the pinion recess, and the two transition zones.

The hub circumventing portion may have a hub circumventing angular distance extending between the first end of the hub circumventing portion and the second end of the hub circumventing portion which is between 250 degrees±25 degrees.

The pinion recess may have a pinion recess angular distance extending between a first end of the pinion recess and a second, opposite, end of the pinion recess which is between 20 degrees±5 degrees.

Each transition zone may have a transition zone angular distance extending between a first end of the transition zone and a second, opposite, end of the transition zone which is between 45 degrees±10 degrees. Preferably, the two transition zones have the same transition zone angular distance.

As referred to herein, the term “stepped transition” generally refers to a transition which is formed by at least one step and thereby forms a non-continuous transition between an end of the hub circumventing portion and the pinion recess. Thus, the stepped transition zone comprises at least one step for providing the stepped transition.

The hub circumventing portion may be configured to be positioned adjacent a driven gear for an eccentric. The pinion recess may be configured to receive a pinion and a countershaft assembly. The gear well is provided for facilitating lubrication of gears in crushers. The disclosed gear well is advantageous as it provides for reduced overall stresses in the castings of the crusher compared to conventional gear wells. The gear well is also provided facilitating a uniform stress distribution. By being able to reduce the overall stress as well as providing for a uniform stress distribution, an improved strength of the gear well is achieved and thereby also an improved lifetime of the gear well.

The gear well is advantageous as it provides improved fatigue strength due to the lowered overall stresses as well as the improved stress distribution both in crushing load case and casting simulation. The inventors have surprisingly found that by providing a gear well with a stepped transition as described herein, the maximum principal stress range reduction may be in the range of 35-40% compared to gear wells known in the art.

The gear well is further advantageous as it provides the above features/advantages without challenging the exterior shape of the gear well. This is advantageous as it allows for the disclosed gear well to replace existing gear wells already present in a crusher without the need to modify or redesign the crusher. Thus, the disclosed gear well may be a retrofitting part for already existing crushers. Put differently, the disclosed gear well comprises a novel and inventive interior structure which facilitates the provision of the above stated advantages without challenging the exterior shape of the gear well.

The gear well is yet further advantageous in that it prevents, or at least reduces the risk of, failure during use. Additionally, providing a gear well with a stepped transition improves casting processes since a better distribution of stresses in the cast part is obtained thereby.

The gear well is yet further advantageous as it allows for mitigating oil frothing or foaming in the gear well as well as an efficient oil lubrication of the gears. Foam is an efficient insulator so the temperature of the oil can be difficult to control. Problems that may arise as a result of foaming are fluctuations in oil pressure, oil pump cavitation, loss of oil through breathers and dipsticks and decrease in lubrication and cooling efficiencies.

According to some embodiments, the transition zone comprises an angled portion, which is angled with respect to a plane transverse to the central axis, and a first vertical portion, wherein the angled portion extends between an end of the hub circumventing portion and the first vertical portion and the first vertical portion extends between the angled portion and the pinion recess. Put differently, the angled portion is inclined with an angle in relation to a transverse axis, being transverse to the central axis of the hub.

This is advantageous as it allows for overall stress reductions in the castings during production of the gear well.

According to some embodiments, the transition zone comprises at least two steps for providing the stepped transition. This is advantageous as it allows for each step of the transition zone to be smaller, i.e., having a smaller height seen along a central axis compared to when only one step is provided. By being able to provide smaller steps, the pathway for the oil may be smoother and thereby frothing of oil may be reduced. This is further advantageous as it allows reducing the overall stresses in the gear well and thereby the durability of the gear well is increased, resulting in an improved lifetime.

According to some embodiments, the at least two steps are arranged at different angular positions with respect to a central axis of the hub.

As referred to herein, the term “arranged at different angular positions with respect to a central axis of the hub” generally refers to that a respective step has a main radial extension in a radial direction which is different from the radial direction in which the other step has a main radial extension.

This is advantageous as it allows the transition zone to have a seamless transition between the hub circumventing portion and the bottom of the pinion recess. This is further advantageous as it allows for a more uniform wall thickness. Put differently, it facilitates possibilities of lowering casting defects due to less drastic changes in wall thickness compared to conventional gear wells.

According to some embodiments, the transition zone comprises an angled portion, a first vertical portion, and a second vertical portion, wherein the second vertical portion connects an end of the hub circumventing portion with the angled portion, the angled portion extends between the second vertical portion and the first vertical portion, and the first vertical portion extends between the angled portion and the pinion recess.

As referred to herein, the term “connects” generally refers to that the second vertical portion at least extends between an end of the hub circumventing portion and the angular portion. However, in some embodiments, at least a part of the second vertical portion may also extend to the first vertical portion and/or to the pinion recess. Thus, the second vertical portion may be designed in different ways.

This is advantageous as it allows for a two-step transition zone to be formed such that an improved gear well is achieved. Again, as said above, the two-step transition zone allows for oil supply in a smooth way within the gear well as well as for a reduction of the overall stresses in the casting.

According to some embodiments, the first vertical portion has an extension in an axial direction and an extension in a radial direction of the hub, and the second vertical portion has an extension in an axial direction and an extension in a tangential direction of the hub.

The axial direction is parallel with the central axis of the hub. The radial direction is preferably radial in relation to the extension of the hub.

This is advantageous as it allows for the transition zone to be arranged based on the exterior geometry of the gear well, e.g., it allows the transition zone to circumvent a portion of the hub as well as to extend between an end of the hub circumventing portion and the pinion recess.

According to some embodiments, the axial extension of the first vertical portion is uniform, and the axial extension of the second vertical portion is non-uniform. This provides an efficient stepped transition zone.

According to some embodiments, the axial extension of the first vertical portion is in the range of 5-120 mm, such as 10-115 mm.

The axial extension of the second vertical portion may be in the range of 5-250 mm, such as 25-150 mm. Again, as said above, the axial extension of the second vertical portion is non-uniform, thereby the axial extension of the vertical portion is varying along the axial extension in a range between 5-250 mm, such as 25-150 mm.

According to some embodiments, the angled portion has an extension in a radial direction and an extension in a tangential direction of the hub. Again, as said above, this is advantageous as it allows for an improved structure of the gear well, providing a stronger gear well without the need of modifying the exterior shape or geometry thereof.

According to some embodiments, the tangential extension of the angled portion is equal to the tangential extension of the second vertical portion. Expressed differently, the length of the tangential extension of the angled portion is the same as the length of the tangential extension of the second vertical portion. It is also possible to provide an angled portion with a tangential extension that is shorter than the tangential extension of the second vertical portion, or with a tangential extension that is longer than the tangential extension of the second vertical portion, within the concept of the present disclosure. It is understood by the skilled person that a tangential direction of the hub is a direction of a tangent to a portion of the hub. Thus, the angled portion may, in some embodiments, have a tangential extension in the direction of a tangent of a portion of the hub which is different from a tangent of another portion of the hub in the direction of which the second vertical portion has a tangential extension.

According to some embodiments, the angled portion has a downward slope towards the pinion recess.

This is advantageous as it facilitates the transition zone to extend between the end of the hub circumventing portion and the pinion recess in a smooth and desirable way such that the hub circumventing portion and the pinion recess may be connected via the transition zone.

According to some embodiments, an angle between the bottom of the pinion recess and the downward slope of the angled portion is from 130 to 175 degrees, such as from 145 to 160 degrees.

This is advantageous as it avoids the need of including a precipice-like corner in the gear well, as is included in conventional gear wells.

According to some embodiments, the at least two steps have rounded corner transitions.

This is advantageous as the rounded corner transitions provides for an improved strength of the gear due to reduced overall stresses in the castings compared to a gear well having a sharp corner transition.

The transition zone may comprise rounded corner transitions. The hub circumventing portion may comprise rounded corner transitions. The pinion recess may comprise rounded corner transitions. Thus, in some embodiments, all corners present in the gear well have rounded corner transitions. This is advantageous in that it reduces the overall stresses in the gear well and provides for a more uniform stress distribution in the castings.

According to some embodiments, the transition zone comprises more than one angular portion and more than two vertical portions, wherein each angular portion extends between two vertical portions.

Preferably, the gear well comprises one more vertical portion than the number of angular portions such that the stepped transition is formed.

According to a second aspect of the disclosure, these and other objects are also achieved, in full or at least in part, by a crusher comprising a gear well as disclosed herein.

Effects and features of the second aspect are largely analogous to those described above in connection with the first aspect. Embodiments mentioned in relation to the first aspect are largely compatible with the second aspect. It is further noted that the inventive concepts relate to all possible combinations of features unless explicitly stated otherwise.

A further scope of applicability of the present disclosure will become apparent from the detailed description given below. However, it should be understood that the detailed description and specific examples, while indicating preferred embodiments of the disclosure, are given by way of illustration only, since various changes and modifications within the scope of the disclosure will become apparent to those skilled in the art from this detailed description.

Hence, it is to be understood that this disclosure is not limited to the particular component parts of the device described or steps of the methods described as such device and method may vary. It is also to be understood that the terminology used herein is for purpose of describing particular embodiments only and is not intended to be limiting. It must be noted that, as used in the specification and the appended claim, the articles “a”, “an”, “the”, and “said” are intended to mean that there are one or more of the elements unless the context clearly dictates otherwise. Thus, for example, reference to “a unit” or “the unit” may include several devices, and the like. Furthermore, the words “comprising”, “including”, “containing” and similar wordings do not exclude other elements or steps.

### BRIEF DESCRIPTIONS OF THE DRAWINGS

The disclosure will by way of example be described in more detail with reference to the appended drawings, which show presently preferred embodiments of the disclosure.

FIG. 1 shows a perspective view of a gear well known in the art.

FIG. 2 shows cross-sectional view of the gear well known in the art and as illustrated in FIG. 1.

FIG. 3 shows a cross-sectional view of a gear well according to an embodiment of the present disclosure.

FIGS. 4a-b show detailed views of a transition zone of the gear well as illustrated in FIG. 3 according to an embodiment of the present disclosure.

FIGS. 5a-b show detailed views of a transition zone of a gear well according to an embodiment of the present disclosure.

FIG. 6 shows a detailed view of a transition zone of a gear well according to an embodiment of the present disclosure.

FIG. 7 shows a detailed view of a transition zone of a gear well according to an embodiment of the present disclosure.

FIG. 8 shows a detailed view of a transition zone of a gear well according to an embodiment of the present disclosure.

### DETAILED DESCRIPTION

The present disclosure will now be described more fully hereinafter with reference to the accompanying drawings, in which currently preferred embodiments of the disclosure are shown. This disclosure may, however, be embodied in many different forms and should not be construed as limited to the embodiments set forth herein; rather, these embodiments are provided for thoroughness and completeness, and to fully convey the scope of the disclosure to the skilled person.

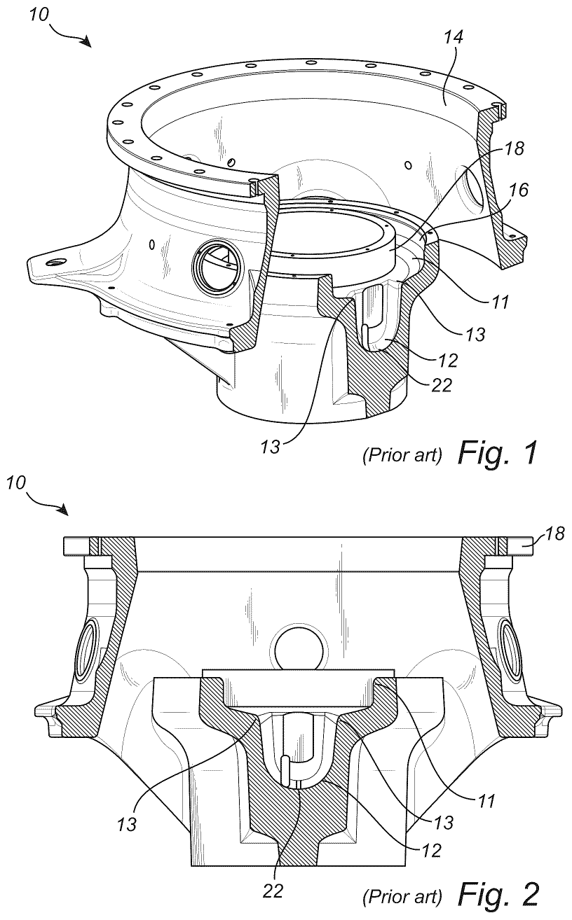

FIGS. 1 and 2 illustrate a gear well 10 known in the art. The gear well 10 is configured to lubricate gears in a crusher, such as a gyratory crusher or a cone crusher known in the art. Although the crusher is not illustrated, the skilled person would understand that the gear well is configured to be arranged in the crusher known in the art. The gyratory or cone crusher are suitable for size reduction and shaping of material in the downstream of a crushing circuit. The material size is reduced by continuous compression between a fixed element, known as a bowl liner, and a moving element, known as a mantle. In addition, the crusher comprises a head assembly including a crusher head that gyrates about a vertical axis within a bowl attached to a main frame of the crusher. The crusher head is assembled surrounding an eccentric that rotates about a shaft to impart the gyratory motion to the crusher head which crushes rock, stone, or other material as the material travels through a crushing gap between the crusher head and the bowl. The crushed material exits the crusher through the bottom of the crushing gap. The eccentric can be driven by a variety of power drives, such as an attached gear, driven by a pinion and countershaft assembly, and a number of mechanical power sources, such as electrical motors or combustion engines.

The gear well 10 comprises a hub circumventing portion 11, a pinion recess 12 and two transition zones 13. The hub circumventing portion 11 has a first sidewall 14 and a second sidewall 16, defining a groove extending therebetween. The pinion recess 12 has a bottom 22. Each transition zone 13 extends between an end of the hub circumventing portion 11 and the pinion recess 12. Each transition zone 13 has a sharp corner transition, also referred to herein as a precipice, at which the groove transitions into the pinion recess through a drastic increase of the depth of the groove.

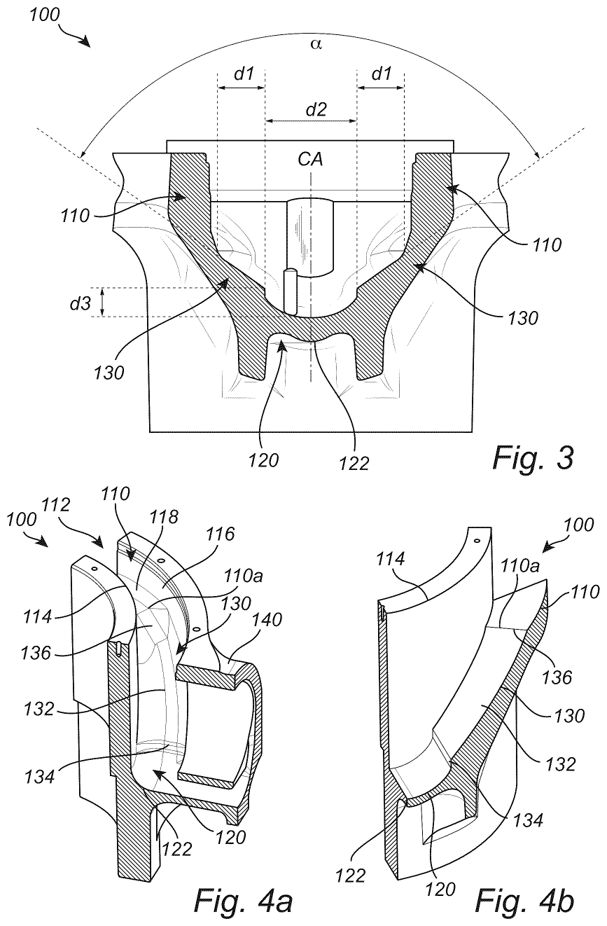

FIG. 3 illustrates a cross-sectional view of a gear well 100 according to an embodiment of the present disclosure. The gear well 100 may be used in a crusher, e.g., a gyratory crusher or a cone crusher, for lubricating gears in the crusher. The gear well 100 comprises a hub circumventing portion 110, a pinion recess 120 and two transition zones 130. However, it should be noted that the gear well 100 may comprise only one transition zone 130. Thus, the gear well 100 may comprise at least one or two transition zones 130. The hub circumventing portion 110 circumvents at least a portion of a hub (not illustrated) of the crusher. The hub circumventing portion 110 extends from one transition zone 130 to the other 130. The pinion recess 120 extends between the two transition zones 130. Thus, the respective transition zone 130 extends between a respective end of the hub circumventing portion 110 and a respective end of the pinion recess 120. The pinion recess 120 has a pinion bottom 122. The pinion recess 120 is configured to receive a pinion and a countershaft assembly. The pinion recess 120 has an extension d2 in a radial direction RD. The extension d2 may be in the range of 100-300 mm, preferably 145-225 mm. The pinion recess 120 has an extension d3 in an axial direction AD. The extension d3 may be in the range of 30-100 mm, preferably 50-80 mm. The extensions d2, d3 may be chosen based on a geometry of the pinion and the countershaft assembly.

The transition zones 130 have a respective extension d1, d1′ in the radial direction RD. The extension d1 may be in the range of 50 -150 mm. The extension d1′ may be in the range of 50 -150 mm. Preferably, the extension d1 is equal to the extension d1′ such that a uniform gear well is formed.

An angle α is formed between the two transition zones 130. The angle α may be in the range of 90-130 degrees, preferably 100-120 degrees.

FIGS. 4a and 4b illustrate the gear well 100 also shown in FIG. 3 in further detail. FIG. 4a illustrates a concept design of the gear well 100 and FIG. 4b illustrates a base shape of the gear well 100. Further to what has been discussed in connection with FIG. 3, the hub circumventing portion 110 comprises a groove 112 which has a first sidewall 114, a second sidewall 116 and a groove base 118. The hub circumventing portion 110 is configured to hold lubricating oil which may be supplied within the gear well 100 such that the gears of the crusher are lubricated.

FIGS. 4a and 4b depict one of the transition zones 130 as illustrated in FIG. 3. However, it should be noted that the two transition zones 130 preferably are mirrored in geometry and thus, the features of the transition zone 130 of FIGS. 4a and 4b may be comprised in the other transition zone 130 as well. The transition zone 130 provides a stepped transition of the groove 112 from the hub circumventing portion 110 to the bottom 122 of the pinion recess 120. In this exemplifying embodiment, the transition zone 130 comprises two steps for providing the stepped transition. The transition zone 130 comprises an angled portion 132, a first vertical portion 134, and a second vertical portion 136 such that the two-step stepped transition is formed. The second vertical portion 136 extends between an end 110a of the hub circumventing portion 110 and the angled portion 132, such that the second vertical portion 136 connects the end 110a of the hub circumventing portion 110 with the angled portion 132. The angled portion 132 extends between the second vertical portion 136 and the first vertical portion 134. The first vertical portion 134 extends between the angled portion 132 and the pinion recess 120. Thereby, the transition zone 130 forms a transition between the end 110a of the hub circumventing portion 110 and the pinion recess 120.

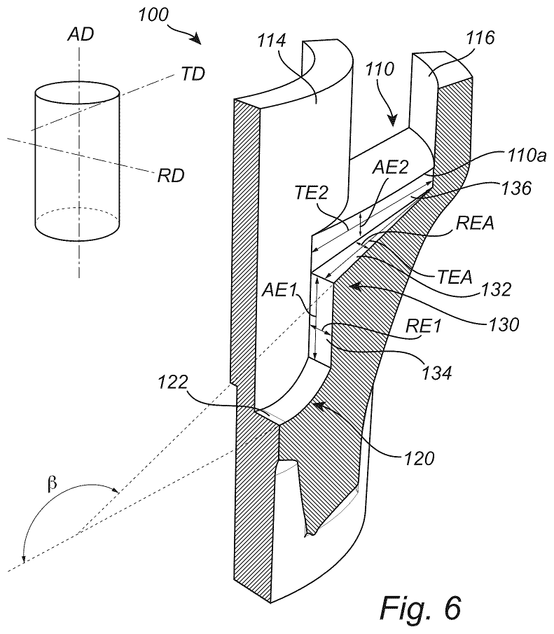

As best illustrated in FIG. 6, the angled portion 132 has an extension REA in the radial direction RE and an extension TEA in the tangential direction TD. The first vertical portion 134 has an extension AE1 in the axial direction AD and an extension RE1 in the radial direction RD. The second vertical portion 136 has an extension AE2 in the axial direction AD and an extension TE2 in the tangential direction TD.

Referring back to FIGS. 4a and 4b, the hub circumventing portion 110, the pinion recess 120 and the transition zones 130 are all arranged to not require a change of the external geometry of the gear well 100, with respect to a conventional gear well. The angled portion 132 has a downward slope towards the pinion recess 130. Thereby, the angled portion 132 has an upper end and a lower end which are arranged at a distance from each other seen along the central axis CA. Further, in order for the transition zone 130 to follow the exterior geometry of the hub, the two steps, and especially the two vertical portions 134, 136 are arranged at different angular positions with respect to a central axis CA of the hub.

As best illustrated in FIG. 4a, the transition zone 130 comprises rounded corner transitions. Put differently, the portions 132, 134, 136 of the transition zone 130 comprise rounded corner transitions as opposed to sharp corner transitions known in the art and illustrated in FIGS. 1 and 2. Typically, the rounded corner transitions may have a minimum radius of 5 mm and upwards. Further, the hub circumventing portion 110 and the pinion recess 120 also comprise rounded corner transitions. Thereby, an improved stress distribution and overall stress reduction of the casted part are achieved.

With reference to FIG. 4b, the transition zone 110 is illustrated wherein the rounded corner transitions have been excluded. This is mainly for illustrative purposes. FIG. 4b further shows that the second vertical portion 136 has a smaller axial extension AE2 compared to the first vertical portion 134. It should however be noted that the other way around may be possible as well, e.g., embodiments in which the first vertical portion 134 has a smaller axial extension AE1 compared to the second vertical portion 136 are also achievable within the concept of the present disclosure. It may also be possible that the first and second vertical portions 134, 136 have the same axial extensions AE1, AE2.

The gear well 100 further comprises a pinion housing 140 configured to receive the pinion and countershaft assembly.

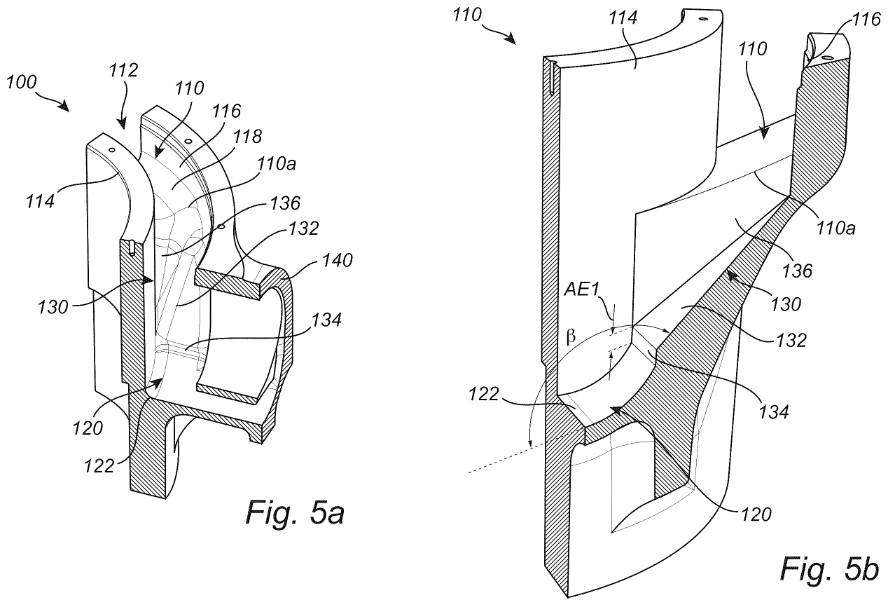

With reference to FIGS. 5a-b, another embodiment of the present disclosure is shown, wherein the angled portion 132, the first vertical portion 134 and the second vertical portion 136 of the transition zone are differently arranged as compared to the previously described transition zone 130. FIG. 5a illustrates a concept view of the gear well 100 and FIG. 5b illustrates a base shape of the gear well 100.

In this exemplifying embodiment, the second vertical portion 136 extends between the end 110a of the hub circumventing portion 110 and the angled portion 132. The angled portion 132 extends between the second vertical portion 136 and the first vertical portion 134. The first vertical portion 134 extends between the angled portion 132 and the bottom 122 of the pinion recess 120. As depicted in FIGS. 5a and 5b, the first vertical portion 134 has a uniform axial extension AE1 and the second vertical portion 136 has a non-uniform axial extension AE2. This allows the transition zone 130 to be altered with respect to a gear well known in the art without affecting the exterior shape or geometry of the gear well 100.

The angled portion 132 has a downward slope towards the pinion recess 120. An angle β between the bottom 122 of the pinion recess 120 and the downward slope of the angled portion 132 is illustrated. The angle β is preferably in the range of 130-175 degrees, such as 145-160 degrees. In FIG. 5b, the angle β is approximately 145 degrees. The downward slope of the angled portion 132 depends on the axial extension of the first and the second vertical portion 134, 136. Thereby, the angle β depends indirectly on the downward slope of the angled portion 132.

With reference to FIG. 6, another embodiment of the present disclosure is shown wherein the angled portion 132, the first vertical portion 134 and the second vertical portion 136 of the transition zone 130 are arranged differently as compared to the previously described transition zones 130. In the embodiment shown in FIG. 6, the first vertical portion 134 has a greater axial extension AE1 compared to the first vertical portion 134 of the embodiment illustrated in FIGS. 5a and 5b. As a consequence, the second vertical portion 136 has a smaller axial extension AE2 compared to the second vertical portion 136 of the embodiment illustrated in FIGS. 5a and 5b. The angle β depicted in FIG. 6 is in this embodiment approximately 160 degrees. Generally, when the axial extension AE1 of the first vertical portion 134 increases and the axial extension AE2 of the second vertical portion 136 is maintained, the downward slope of the angled portion 132 decreases and the angle β increases.

It should be noted that FIG. 6 illustrates a base shape of the gear well 100. However, although not illustrated, the corner transitions of the transition zone 130 but also of the hub circumventing portion 110 and the pinion recess may be rounded corner transitions for the reasons discussed above.

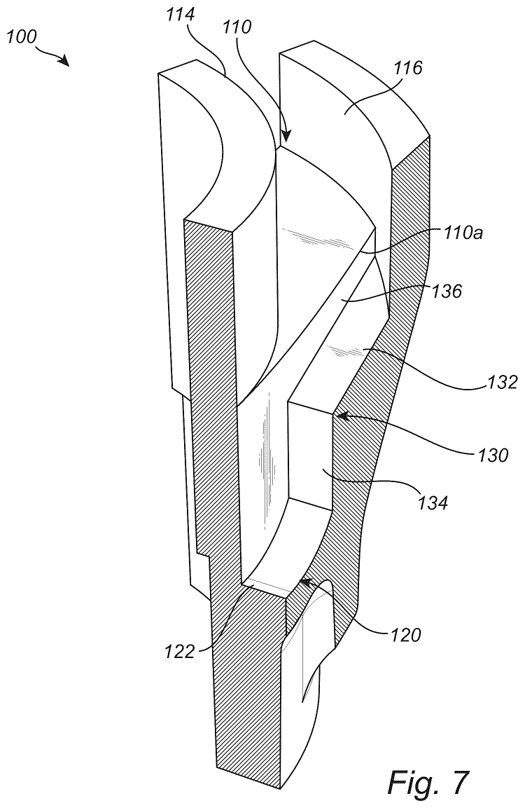

With reference to FIG. 7, yet another embodiment according to the present disclosure is shown, wherein the angled portion 132, the first vertical portion 134 and the second vertical portion 136 of the transition zone 130 are arranged differently as compared to the previously described embodiments.

In this exemplifying embodiment, the second vertical portion 136 connects the end 110a of the hub circumventing portion 110 with the angled portion 132. In addition, the second vertical portion 136 partly extends between the end 110a of the hub circumventing portion 110 and the angled portion 110 and partly between the end 110a of the hub circumventing portion 110 and the pinion recess 120.

It should be noted that FIG. 7 illustrates a base shape of the gear well 100.

However, although not illustrated, the corner transitions of the transition zone 130 but also of the hub circumventing portion 110 and the pinion recess may preferably be rounded for the reasons previously discussed.

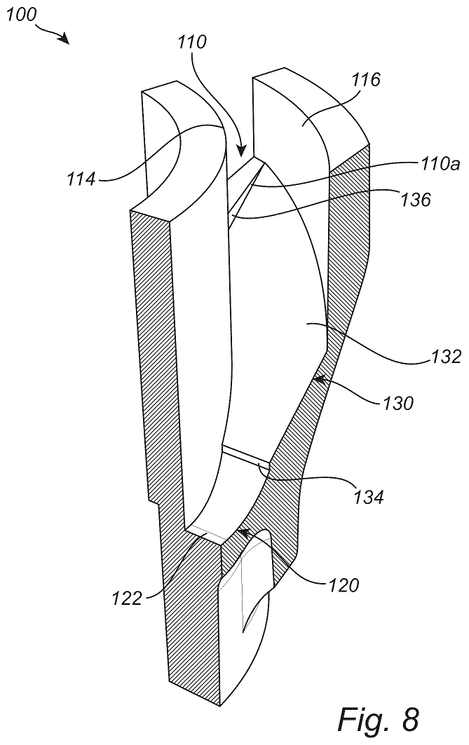

With reference to FIG. 8, yet another embodiment according to the present disclosure is shown, wherein the angled portion 132, the first vertical portion 134 and the second vertical portion 136 are arranged differently as compared to the previously described embodiments.

In the embodiment shown in FIG. 8, the second vertical portion 136 extends between the end 110a of the hub circumventing portion 110 and the angled portion 132. The angled portion 132 extends between the first and second vertical portions 134, 136. The first vertical portion 134 extends between the angled portion 132 and the pinion recess 120. The angled portion 132 is here slightly curved around a portion of the hub as a result of the first and second vertical portions 134, 136 having relatively short axial extensions AE1, AE2 in the axial direction AD.

It should be noted that FIG. 8 illustrates a base shape of the gear well 100. Providing corner transitions of the transition zone 130 but also of the hub circumventing portion 110 and the pinion recess that are rounded is also possible within the concept of the present disclosure and may be preferable for the reasons discussed herein.

The person skilled in the art realizes that the present disclosure by no means is limited to the preferred embodiments described above. On the contrary, many modifications and variations are possible within the scope of the appended claims.

For example, the transition zone 130 may only comprise the angled portion 132 and the first vertical portion 134. In this case, the angled portion 132 extends between the end 110a of the hub circumventing portion 110 and the first vertical portion 134. The first vertical portion 134 extends between the angled portion 132 and the pinion recess 120. For further examples, the transition zone 130 may comprise more than two vertical portions and one angled portion. In an example, the transition zone 130 comprises one more vertical portion than the number of angular portions for forming the stepped transition.

Additionally, variations to the disclosed embodiments can be understood and effected by the skilled person in practicing the claimed disclosure, from a study of the drawings, the disclosure, and the appended claims.

1.-16. (canceled)

17. A gear well for a crusher comprising:
a hub circumventing portion, arrangeable for circumventing at least a portion of a hub of the crusher, and comprising a groove having first and second side walls and a groove base;
a pinion recess having a bottom; and
a transition zone extending between an end of the hub circumventing portion and the pinion recess,
wherein the transition zone provides a stepped transition of the groove from the hub circumventing portion to the bottom of the pinion recess,
wherein the transition zone comprises a step for providing the stepped transition, and
wherein the transition zone comprises an angled portion, which is angled with respect to a plane transverse to the central axis, and a first vertical portion, wherein the angled portion extends between the end of the hub circumventing portion and the first vertical portion, and the first vertical portion extends between the angled portion and the pinion recess.

18. The gear well according to claim 17, wherein the transition zone comprises at least two steps for providing the stepped transition.

19. The gear well according to claim 18, wherein the at least two steps are arranged at different angular positions with respect to a central axis of the hub.

20. The gear well according to claim 18, wherein the transition zone comprises an angled portion, a first vertical portion, and a second vertical portion, wherein the second vertical portion connects the end of the hub circumventing portion with the angled portion, the angled portion extends between the second vertical portion and the first vertical portion, and the first vertical portion extends between the angled portion and the pinion recess.

21. The gear well according to claim 20, wherein the first vertical portion has an extension in an axial direction and an extension in a radial direction of the hub, and the second vertical portion has an extension in an axial direction and an extension in a tangential direction of the hub.

22. The gear well according to claim 21, wherein the axial extension of the first vertical portion is uniform, and the axial extension of the second vertical portion is non-uniform.

23. The gear well according to claim 21, wherein the axial extension of the first vertical portion is in the range of 5-120 mm.

24. The gear well according to claim 17, wherein the angled portion has an extension in a radial direction and an extension in the tangential direction of the hub.

25. The gear well according to claim 24, wherein the tangential extension of the angled portion is equal to the tangential extension of the second vertical portion.

26. The gear well according to claim 17, wherein the angled portion has a downward slope towards the pinion recess.

27. The gear well according to claim 26, wherein an angle β between the bottom of the pinion recess and the downward slope of the angled portion is from 130 to 175 degrees, such as from 145 to 160 degrees.

28. The gear well according to claim 17, wherein the stepped transition has rounded corner transitions.

29. The gear well according to claim 17, wherein the transition zone comprises more than one angled portion and more than two vertical portions, wherein each angled portion extends between two vertical portions.

30. A crusher comprising a gear well according to claim 17.
